(19) United States
(12) Patent Application Publication
(10) Pub. No.: US 2014/0326780 A1
(43) Pub. Date: Nov. 6, 2014

(54) WELDING DEVICE FOR MASK FRAME ASSEMBLY AND METHOD OF WELDING MASK FRAME ASSEMBLY

(71) Applicant: Samsung Display Co,. Ltd., Yongin-city (KR)

(72) Inventor: Jeong-Won Han, Yongin-city (KR)

(73) Assignee: Samsung Display Co,. Ltd., Yongin-city (KR)

(21) Appl. No.: 14/034,988

(22) Filed: Sep. 24, 2013

(30) Foreign Application Priority Data
May 2, 2013 (KR) 10-2013-0049606

(51) Int. Cl. B05C 21/00; B23K 31/02

(52) U.S. Cl. CPC B05C 21/005; B23K 31/02
USPC 228/103; 228/33

(57) ABSTRACT

A welding device for a mask frame assembly, includes a chamber maintained in a vacuum state, a mask frame disposed in the chamber, a support frame disposed in the chamber and configured to support the mask frame, a mask disposed in the chamber and configured to be welded to the mask frame, a tensile unit disposed in the chamber, installed on the support frame and configured to apply a tensile force to stretch the mask; and a welding unit disposed in the chamber and configured to weld the mask frame and the mask to each other.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

This application claims the benefit of Korean Patent Application No. 10-2013-0049606, filed on May 2, 2013, in the Korean Intellectual Property Office, the disclosure of which is incorporated herein in its entirety by reference.

### BACKGROUND

1. Field

The present disclosure relates to a welding device for a mask frame assembly and a method of wedding mask frame assembly.

2. Description of the Related Technology

Electronic devices based on mobility are being widely used. Among these mobile electronic devices, tablet personal computers (PCs), in addition to small electronic devices, such as mobile phones, are being widely used.

These mobile electronic devices generally each include a display unit that provides a user with visual information, such as an image or video, so as to support various functions. As components for driving the display unit have recently been miniaturized, an importance of the display unit in the mobile electronic devices has been increasing gradually, and structures that can be bent to have a predetermined angle while laid flat have also been developed.

An organic material may be formed on the display unit so as to be used as an emission layer. The organic material may be formed using various methods. For example, some methods of forming an organic material include an organic material deposition method in which an organic material is formed by evaporation, a laser thermal transfer method in which an organic material is formed by a radiating laser, and an inkjet method in which an organic material is formed by using ink.

In the organic material deposition method, the organic material is typically heated and evaporated and then is allowed to pass through open patterns formed on a mask and is deposited so that the organic material can be deposited only on a desired portion of the display unit. In the organic material deposition method, deposition patterns of the organic material vary according to deformation or alignment of the mask, which may affect definition of the display unit.

### SUMMARY OF CERTAIN INVENTIVE ASPECTS

The present disclosure provides a welding device for a mask frame assembly and a method of wedding mask frame assembly, in which the mask frame assembly may be fabricated in the same environment as an actual deposition process.

According to an aspect of the present invention, there is provided a welding device for a mask frame assembly, the welding device including: a chamber maintained in a vacuum state; a mark frame disposed in the chamber; a support frame disposed in the chamber and configured to support the mask frame; a mask disposed in the chamber and configured to be welded to the mask frame; a tensile unit disposed in the chamber, the tensile unit installed on the support frame and configured to apply a tensile force to stretch the mask; and a welding unit disposed in the chamber, the welding unit configured to weld the mask frame and the mask to each other.

The welding device may further include a contact unit disposed in the chamber and configured to contact a surface of the mask.

The contact unit may include: a test substrate; and an adhesion unit configured to adhere to the test substrate.

The adhesion unit may include an electromagnet.

The contact unit may include: a heat source; and an adhesion unit connected to the heat source.

The contact unit may further include a test substrate attached to at least one of the heat source or the adhesion unit.

The heat source may be attached to a top surface or bottom surface of the adhesion unit.

The adhesion unit may include an electromagnet.

The welding device may further include an alignment detection unit configured to detect an alignment state of the mask.

The alignment detection unit may be disposed to face the welding unit.

The contact unit may include a test substrate contacting the mask, and the test substrate may include patterns, where the patterns are detectable by the alignment detection unit.

Respective sizes of the patterns may be in a micrometer scale or in a nanometer scale.

The welding device may further include a heat source disposed in the chamber and configured to heat at least one of the mask frame and the mask.

According to another aspect of the present invention, there is provided a method of welding a mask frame assembly, the method including: maintaining a chamber in a vacuum state; disposing a support frame supporting a mask frame in the chamber; disposing a mask on the mask frame in the chamber; contacting a surface of the mask with a substrate; detecting an alignment state of the mask; applying a tensile force to the mask based on the detected alignment of the mask; and welding the mask frame and the mask to each other using the welding unit.

### BRIEF DESCRIPTION OF THE DRAWINGS

The above and other features and advantages of the present invention will become more apparent by describing in detail certain embodiments thereof with reference to the attached drawings in which:

FIG. 1 is a conceptual view illustrating a welding device for a mask frame assembly according to an embodiment of the present invention;

FIG. 2 is a plan view illustrating a test substrate illustrated in FIG. 1;

FIG. 3 is a conceptual view illustrating a welding device for a mask frame assembly according to another embodiment of the present invention; and

FIG. 4 is a conceptual view illustrating a welding device for a mask frame assembly according to another embodiment of the present invention.

### DETAILED DESCRIPTION OF CERTAIN INVENTIVE EMBODIMENTS

As used herein, the term “and/or” includes any and all combinations of one or more of the associated listed items. Expressions such as “at least one of,” when preceding a list of elements, modify the entire list of elements and do not modify the individual elements of the list.

The invention will now be described more fully hereinafter with reference to the accompanying drawings, in which illustrative embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. It will be further understood that although the terms first and second are used herein to describe various elements, these elements should not be limited by these terms. These terms are only used to distinguish one element from another element.

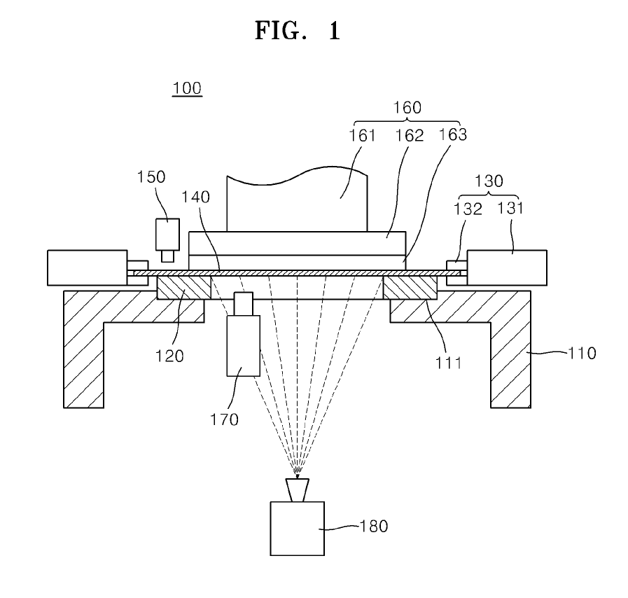

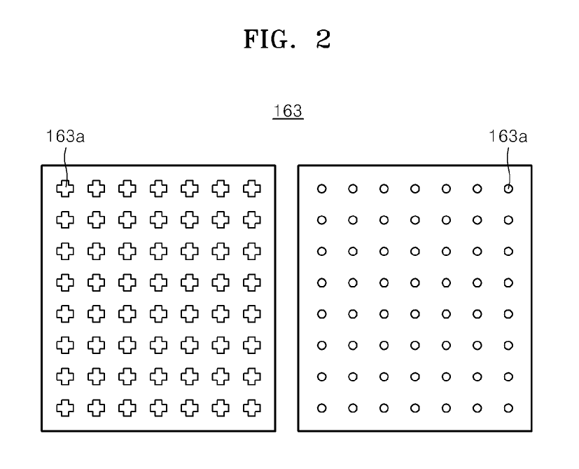

FIG. 1 is a conceptual view illustrating a welding device 100 for a mask frame assembly according to an embodiment of the present invention. FIG. 2 is a plan view illustrating a test substrate 163 illustrated in FIG. 1.

Referring to FIGS. 1 and 2, the welding device 100 for the mask frame assembly may include a chamber (not shown) in which a vacuum state is maintained. In this case, the chamber (not shown) may be formed so that the inside of the chamber may be separated from the outside. In particular, a pipe (not shown) is installed at the chamber so as to guide air inside the chamber to the outside of the chamber, and a pump (not shown) is installed at the pipe so as to pump out air from the inside of the chamber or to pump in air outside the chamber to the inside of the chamber.

The welding device 100 for the mask frame assembly may include a support frame 110, which is disposed in the chamber and on which a mask frame 120 is mounted. In this case, a mounting groove 111 may be formed in the support frame 110 so that ends of the mask frame 120 may be mounted in the mounting groove 111.

The welding device 100 for the mask frame assembly may include a tensile unit 130 that is disposed in the chamber and installed on the support frame 110. In this case, the tensile unit 130 may apply a tensile force stretching a mask 140 to be welded to the mask frame 120. In particular, the tensile unit 130 may include an actuator 131, such as a cylinder, and a holder 132 that holds a part of the mask 140.

In some embodiments, a plurality of tensile units 130 may be provided. The plurality of tensile units 130 may be disposed spaced apart from each other by a predetermined gap and may each hold a part of the mask 140. In such embodiments, a plurality of masks 140 may be provided, and each of the plurality of masks 140 may be maintained in a tensile state by a pair of tensile units 130.

The welding device 100 for the mask frame assembly may further include a welding unit 150 that is disposed in the chamber and welds the mask frame 120 and the mask 140 to each other. The welding unit 150 is similar to a general welding unit that welds the mask frame 120 and the mask 140 to each other and thus, detailed descriptions thereof will be omitted.

The welding device 100 for the mask frame assembly may further include a contact unit 160 that is disposed in the chamber and comes in contact with the surface of the mask 140. The contact unit 160 may include an ascending/descending unit 161 that ascends and/or descends and an adhesion unit 162 attached to the ascending/descending unit 161. In some embodiments, the adhesion unit 162 may include an electromagnet. The adhesion unit 162 may perform a function of generating an electromagnetic force so that the test substrate 163 (described in further detail below) adheres to the adhesion unit 162.

The contact unit 160 may include the test substrate 163 adhered to the adhesion unit 162. The test substrate 163 may be formed of the same material as a material used as a substrate in an actual process. In other embodiments, the test substrate 163 may be formed of a material that is different from the material used as the substrate in the actual process.

Patterns 163a that may be detected by an alignment detection unit 170 may be formed on the surface of the test substrate 163. The patterns 163a may be formed to have various shapes. For example, the patterns 163a may have a cross shape, a circular shape, a rectangular shape, or the like. The sizes of the patterns 163a may be in a micrometer scale or in a nanometer scale.

The welding device 100 for the mask frame assembly may further include a heat source 180 that is disposed in the chamber and heats at least one of the mask frame 120 and the mask 140. The heat source 180 may be disposed below the mask frame 120 and the mask 140 and may heat at least one of the mask frame 120 and the mask 140.

The welding device 100 for the mask frame assembly may include the alignment detection unit 170 disposed below the mask 140. The alignment detection unit 170 may be installed to face the welding unit 150.

The alignment detection unit 170 may include a camera so as to capture an image of the mask 140 or the above-described test substrate 163. The alignment detection unit 170 may detect an alignment state between the mask 140 and the captured image as described above.

In an operation of the welding device 100 for the mask frame assembly, the mask frame 120 may be mounted on the support frame 110. The mask frame 120 may be mounted in and fixed to the mounting groove 111 of the support frame 110.

With the mask frame 120 is fixed to the mounting groove 111 of the support frame 110, as described above, the mask 140 may be disposed on the mask frame 120 and then may be fixed thereto in a tensile state via the tensile unit 130. In this case, the mask 140 may be formed of a plurality of small sheets that are disposed adjacent to each other.

Once the arrangement of the mask 140 is completed, as described above, the adhesion unit 162 and the test substrate 163 may descend via the ascending/descending unit 161. The test substrate 163 may descend and contact the mask 140.

Once the above procedure is completed, the alignment detection unit 170 may determine whether the mask 140 and the test substrate 163 are aligned with respect to each other. The alignment detection unit 170 may check the alignment state of the mask 140 and the test substrate 163 via the patterns 163a of the test substrate 163. The alignment detection unit 170 may determine whether the mask 140 and the test substrate 163 are aligned with respect to each other, by capturing an image between the patterns 163a of the test substrate 163 and patterns of the mask 140. In this case, a method of aligning the mask 140 and the test substrate 163 with respect to each other is similar to a general method of aligning a mask 140 and a substrate used in an organic material deposition process and thus, detailed descriptions thereof will be omitted.

While the above procedure is performed, the heat source 180 may heat at least one of the mask frame 120 and the mask 140 using heat generated in the heat source 180. The heat source 180 may be formed in one of various forms, and for example, the heat source 180 may include a heater.

When at least one of the mask frame 120 and the mask 140 is heated by the heat source 180, as described above, the mask frame 120 and the mask 140 may become deformed. For example, the mask frame 120 and the mask 140 may be twisted or may deviate from their initial positions due to the above-described deformation.

When the test substrate 163 contacts the mask 140, as described above, the shape of the mask 140 may be changed due to the adhesion unit 162. The mask 140 is generally formed of a metal material, and the adhesion unit 162 is configured in the form of an electromagnet, as described above. Thus, the shape of the mask 140 may be changed due to a magnetic force between the mask 140 and the adhesion unit 162.

Thus, the alignment position of the mask 140 may be detected by the alignment detection unit 170 when the mask 140 is deformed, as described above. In particular, the alignment position of the mask 140 may be detected by the alignment detection unit 170 in a similar state to that of a vacuum condition in which an actual organic material deposition process is performed.

While alignment between the mask 140 and the test substrate 163 is performed, as described above, a position of the mask 140 or a tensile force applied to the mask 140 may be varied by using the tensile unit 130. Once position adjustment of the mask 140 is completed, as described above, the mask 140 may be welded to the mask frame 120 by the welding unit 150 and fixed thereto.

Thus, in the welding device 100 for the mask frame assembly, when the mask 140 and the mask frame 120 are welded to each other, a vacuum environment in which an organic material deposition process is performed is emulated so that organic material deposition can be precisely and accurately performed in an actual organic material deposition process. Also, the welding device 100 for the mask frame assembly welds the mask 140 and the mask frame 120 to each other in the emulated vacuum environment so that, when the actual organic material deposition process is performed, deformation of the shape of the open patterns of the mask 140 due to an external environment is minimized and pixel position accuracy (PPA) may be prevented from decreasing.

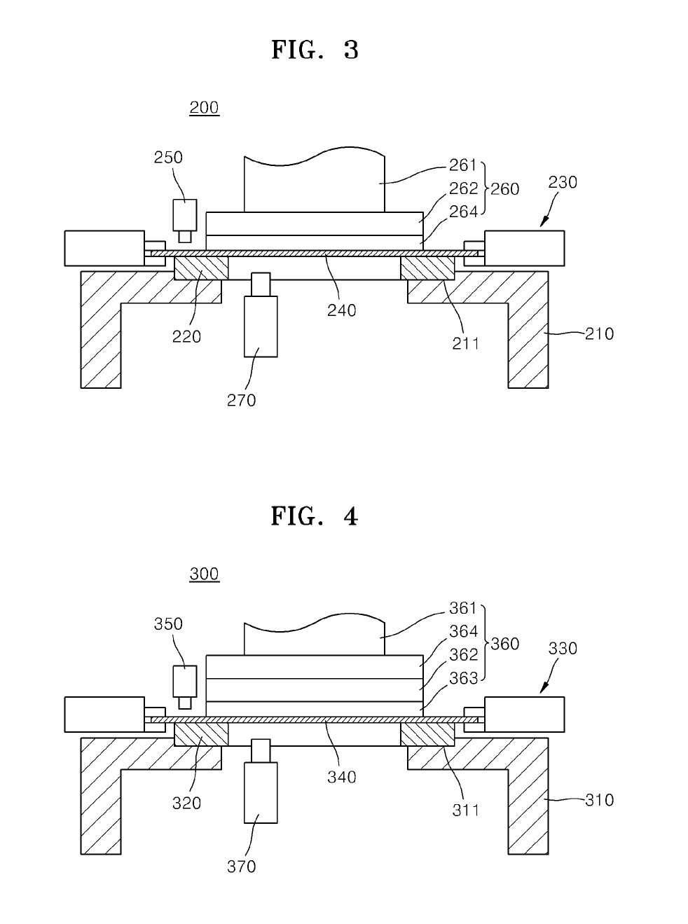

FIG. 3 is a conceptual view illustrating a welding device 200 for a mask frame assembly according to another embodiment of the present invention.

Referring to FIG. 3, the welding device 200 for the mask frame assembly may include a chamber (not shown), a support frame 210, a tensile unit 230, a welding unit 250, a contact unit 260, and an alignment detection unit 270.

The chamber (not shown), the support frame 210, the tensile unit 230, the welding unit 250, and the alignment detection unit 270 are similar to the chamber, support frame 110, tensile unit 130, the welding unit 150, and the alignment detection unit 170 illustrated in FIG. 1 and thus, detailed descriptions thereof will be omitted.

The contact unit 260 may include a heat source 264 and an adhesion unit 262 connected to the heat source 264. The adhesion unit 262 may include an electromagnet, as described above. In addition, the heat source 264 may include any type of device that heats at least one of a mask 240 and a mask frame 220. In particular, the heat source 264 may be formed as a heater having a plate shape and may heat a front surface of the mask 240. The heat source 264 may be installed at the adhesion unit 262 and may be disposed between the mask 240 and the adhesion unit 262.

An operation of the welding device 200 for the mask frame assembly having the above-described structure may be performed in a similar manner to the above-described manner regarding the operation of the welding device 100 for the mask frame assembly. In detail, after the mask frame 220 is mounted in a mounting groove 211 of the support frame 210, the mask 240 may be disposed on the mask frame 220. The tensile unit 230 may fix and support the mask 240 in a tensile state.

Once the above-described procedure is completed, after the heat source 264 is allowed to come in contact with the mask 240 via an ascending/descending unit 261, the adhesion unit 262 operates by generating an electromagnetic force, and the mask 240 may be heated by the heat source 240. The mask 240 may be deformed by a magnetic force and heat, as described above.

While the above-described procedure is performed, the alignment detection unit 270 may detect the position of the mask 240 and may align the mask 240 via the tensile unit 230 and, in response, the tensile unit 230 may apply a tensile force to stretch the mask 240 as necessary for alignment. The alignment detection unit 270 may detect open patterns of the mask 240 or may capture an image of an alignment mask formed on the mask 240, thereby detecting the alignment state of the mask 240.

Once alignment of the mask 240 is completed, as described above, the welding unit 250 may be used to weld the mask 240 and the mask frame 220 to each other.

Thus, in the welding device 200 for the mask frame assembly, when the mask 240 and the mask frame 220 are welded to each other, a vacuum environment in which an organic material deposition process is performed is emulated so that organic material deposition can be precisely and accurately performed in an actual organic material deposition process. In addition, in the welding device 200 for the mask frame assembly, the mask 240 and the mask frame 220 are welded to each other in the emulated environment so that, when the actual organic material deposition process is performed, deformation of the shapes of open patterns of the mask 240 due to an external environment is minimized and PPA may be prevented from decreasing.

FIG. 4 is a conceptual view illustrating a welding device 300 for a mask frame assembly according to another embodiment of the present invention.

Referring to FIG. 4, the welding device 300 for the mask frame assembly may include a chamber (not shown), a support frame 310, a tensile unit 330, a welding unit 350, a contact unit 360, and an alignment detection unit 370.

The chamber (not shown), the support frame 310, the tensile unit 330, the welding unit 350, and the alignment detection unit 370 are similar to the chamber, the support frame 210, the tensile unit 230, the welding unit 250, and the alignment detection unit 270 described above regarding FIG. 3 and thus, detailed descriptions thereof will be omitted.

The contact unit 360 may include a heat source 364 and an adhesion unit 362 connected to the heat source 364. In this case, the adhesion unit 362 may include an electromagnet, as described above. In addition, the heat source 364 may include any type of device that heats at least one of a mask 340 and a mask frame 320. For example, the heat source 364 may be formed as a heater having a plate shape and may heat a front surface of the mask 340. The heat source 364 may be installed at a top surface of the adhesion unit 362. In another example, the heat source 364 may be installed at a bottom surface of the adhesion unit 362.

The contact unit 360 may further include a test substrate 363 attached to the adhesion unit 362. The test substrate 363 is the same as or similar to the test substrate 163 illustrated in FIG. 1 and thus, detailed description thereof will be omitted.

An operation of the welding device 300 for the mask frame assembly having the above-described structure may be performed in the same manner as or a similar manner to the above-described manner regarding the operation of the welding devices 100 or 200 for the mask frame assembly. After the mask frame 320 is mounted in a mounting groove 311 of the support frame 310, the mask 340 may be fixed to the mask frame 320 in a tensile state via the tensile unit 330.

An ascending/descending unit 361 may operate to allow the test substrate 363 to come in contact with the mask 340, and then the heat source 364 may operate to heat at least one of the mask 340 and the mask frame 320. In particular, the test substrate 363 may be maintained in a state in which it is adhered to the adhesion unit 362, as described above.

When the adhesion unit 362 and the heat source 364 operate, as described above, the mask 340 may be deformed by a magnetic force and heat. The tensile unit 330 applies a tensile force to the mask 340, thereby causing deformation of the mask 340.

When the mask 340 is deformed, as described above, the alignment state of the mask 340 may be corrected by the alignment detection unit 370. In this case, the alignment detection unit 370 captures an image of the mask 340, as described above, analyzes the image, thereby determining an alignment position of the mask 340.

Once the above-described procedure is completed, the tensile unit 330 may realign the position of the mask 340. The tensile unit 330 may increase the amount of tensile force applied to the mask 340 or vary the position of the mask 340, thereby aligning the position of the mask 340.

Once the position of the mask 340 is aligned, as described above, the welding unit 350 may be used to weld the mask 340 and the mask frame 320 to each other. The mask 340 may be welded to the mask frame 320 in a deformed state due to a magnetic force and heat, as described above.

Thus, in the welding device 300 for the mask frame assembly, when the mask 340 and the mask frame 320 are welded to each other, a vacuum environment in which an organic material deposition process is performed is emulated so that, when an actual organic material deposition process is performed, organic material deposition can be precisely and accurately performed in an actual organic material deposition process. In addition, in the welding device 300 for the mask frame assembly, the mask 340 and the mask frame 320 are welded to each other in the emulated environment so that, when the actual organic material deposition process is performed, deformation of the shapes of open patterns of the mask 340 is minimized and PPA may be prevented from decreasing.

As described above, in a welding device for a mask frame assembly according to embodiments of the present invention, when a mask and a mask frame are welded to each other, a vacuum environment in which an organic material deposition process is performed is emulated so that organic material deposition can be precisely and accurately performed in an actual organic material deposition process.

In addition, in a welding device for a mask frame assembly according to embodiments of the present invention, the mask and the mask frame are welded to each other in the emulated environment so that, when the actual organic material deposition process is performed, deformation of the shapes of open patterns of the mask due to an external environment is minimized and thus pixel position accuracy (PPA) can be prevented from decreasing.

While the present invention has been particularly shown and described with reference to certain embodiments thereof, it will be understood by those of ordinary skill in the art that various changes in form and details may be made therein without departing from the spirit and scope of the present invention as defined by the following claims.

What is claimed is:

1. A welding device for a mask frame assembly, the welding device comprising:
a chamber maintained in a vacuum state;
a mask frame disposed in the chamber;
a support frame disposed in the chamber and configured to support the mask frame;
a mask disposed in the chamber and configured to be welded to the mask frame;
a tensile unit disposed in the chamber, the tensile unit installed on the support frame and configured to apply a tensile force to stretch the mask; and
a welding unit disposed in the chamber, the welding unit configured to weld the mask frame and the mask to each other.

2. The welding device of claim 1, further comprising a contact unit disposed in the chamber and configured to contact a surface of the mask.

3. The welding device of claim 2, wherein the contact unit comprises:
a test substrate; and
an adhesion unit configured to adhere to the test substrate.

4. The welding device of claim 3, wherein the adhesion unit comprises an electromagnet.

5. The welding device of claim 2, wherein the contact unit comprises:
a heat source; and
an adhesion unit connected to the heat source.

6. The welding device of claim 5, wherein the contact unit further comprises a test substrate attached to at least one of the heat source or the adhesion unit.

7. The welding device of claim 5, wherein the heat source is attached to a top surface or bottom surface of the adhesion unit.

8. The welding device of claim 5, wherein the adhesion unit comprises an electromagnet.

9. The welding device of claim 2, further comprising an alignment detection unit configured to detect an alignment state of the mask.

10. The welding device of claim 9, wherein the alignment detection unit is disposed to face the welding unit.

11. The welding device of claim 9, wherein the contact unit comprises a test substrate contacting the mask, and wherein the test substrate comprises patterns, wherein the patterns are detectable by the alignment detection unit.

12. The welding device of claim 11, wherein respective sizes of the patterns are in a micrometer scale or in a nanometer scale.

13. The welding device of claim 1, further comprising a heat source disposed in the chamber and configured to heat at least one of the mask frame and the mask.

14. A method of welding a mask frame assembly, the method comprising:
maintaining a chamber in a vacuum state;
disposing a support frame supporting a mask frame in the chamber;
disposing a mask on the mask frame in the chamber;
contacting a surface of the mask with a substrate;
detecting an alignment state of the mask;
applying a tensile force to the mask based on the detected alignment of the mask; and
welding the mask frame and the mask to each other using the welding unit.
